(19) United States
(12) Patent Application Publication
(10) Pub. No.: US 2003/0147993 A1
(43) Pub. Date: Aug. 7, 2003

(54) Food products with improved bile acid binding functionality and methods for their preparation

(76) Inventors: Ronald A. Heddleson, Plymouth, MN (US); Alicia A. Perdon, Maple Grove, MN (US); Brent Marston, Ne Hope, MN (US); H. Eugene Hite, Long Lake, MN (US); Shen-Shu Sung, Plymouth, MN (US)

Correspondence Address: GENERAL MILLS, INC., P.O. BOX 1113, MINNEAPOLIS, MN, 55440, US

(21) Appl. No.: 10/062,379

(22) Filed: Feb. 1, 2002

(51) Int. Cl. A21D 10/00

(52) U.S. Cl. 426/42; 426/549; 426/463

(57) ABSTRACT

The present invention is directed to a food product or food product intermediate which incorporates short chain beta glucan or modified short chain beta glucan, those having an average molecular weight of less than 50,000 Daltons, and preferably in the range of 500 to 2,500 Daltons, to enhance bile acid binding capacity resulting in improved hypocholesterolemic effects.

### CROSS REFERENCE TO RELATED APPLICATIONS

None.

### BACKGROUND OF THE INVENTION

High blood cholesterol is a major risk factor for coronary heart disease. Heart disease is dependent on many factors, some of which include diet, family history of the disease, physical activity, and elevated blood levels of low-density lipoprotein (LDL) cholesterol. According to the National Institute of Health (“NIH”), more than 50% of all adult Americans have blood cholesterol levels higher than “desirable” (200 milligrams/deciliter or greater) and half of these people have cholesterol levels that are considered “high” (240 milligrams/deciliter or greater).

Cholesterol in humans comes from primarily two sources, the body's own production of cholesterol (endogenic) and dietary cholesterol. Typically, the average person consumes between 350-400 milligrams of cholesterol daily, while the recommended intake is around 300 milligrams. Increased dietary cholesterol consumption, especially in conjunction with a diet high in saturated fat intake, can result in elevated serum cholesterol. Elevated serum cholesterol is a well-established risk factor for heart disease and therefore there is a need to mitigate the undesired effects of cholesterol accumulation. High cholesterol levels are generally considered to be those total cholesterol levels at 200 milligrams and above or LDL cholesterol levels at 130 milligrams and above.

Lipoproteins contain specific proteins and varying amounts of cholesterol, triglycerides and phospholipids. There are three major classes of lipoproteins and they include very low-density lipoproteins (“VLDL”), low-density lipoproteins (“LDL”) and high-density lipoproteins (“HDL”). The LDLs are believed to carry about 60-70% of the serum cholesterol present in an average adult. The HDLs carry around 20-30% of serum cholesterol with the VLDL having around 1-10% of the cholesterol in the serum. To calculate the level of non-HDL cholesterol present (find the level of LDL or VLDL levels), which indicates risk, the HDL is subtracted from the total cholesterol value. By lowering the total system LDL cholesterol level, it is believed that certain health risks, such as coronary disease and possibly some cancers, that are typically associated with high cholesterol levels, can be reduced.

Numerous studies relating to modifying the intestinal metabolism of lipids have been done to illustrate that such effects can reduce a high cholesterol level. This may be done by hampering the absorption of triglycerides, cholesterol or bile acids. It is believed that certain dietary fibers may assist in lowering serum cholesterol levels by reducing the absorption of dietary cholesterol in the intestines by increasing the binding capacity of the bile acids thereby allowing the dietary cholesterol and bile acids to pass through the body's systems. Support for such theories regarding the mechanism by which cholesterol levels are lowered include by the action of dietary soluble fiber can be found in Welch R. “Oats in human nutrition and health” in The Oat Crop. Chapman and Hall, London, 1995.

A still further theory relates to a reduction in HMG-CoA reductase activity, and thus, the lowering of endogenous cholesterol biosynthesis. Another theory postulates that short-chain fatty acid levels are affected when fiber is fermented to propionate and acetate, which has the potential to lower cholesterol biosynthesis.

In the last 10 years a great deal of research has been concentrated toward the development food products, food intermediates, additives, seasonings, supplements and food ingredients which use certain cereal grains such as oats and barley due to their potentially beneficial hypocholesterolemic effects, i.e., having the ability to reduce blood serum cholesterol levels. The literature to date has provided that the anti-hypercholesterolemic effects imparted by beta glucan containing foods can be attributed to the high viscosity imparted to gut contents by the high molecular weight of beta glucan, i.e., a molecular weight on the order of 1,000,000 Da (Shinnick and Marlet, “Physiological Responses to Dietary Oats in Animal Models”, in Oat Bran, ed. Wood P K, American Association of Cereal Chemists, St. Paul, Minn., pp 113-117 (1993) and Bhatty et al., Journal of Cereal Science, 22, 163 (1995)).

The prior art is replete with methods by which beta glucan can be extracted from cereal grains, including oat groats (hulled, crushed oats) (U.S. Pat. No. 4,028,468 to Hohner et al. (1977)) and barley (U.S. Pat. Nos. 4,804,545 (1989) and 5,013,561 (1991), both to Goering et al.). U.S. Pat. Nos. 5,106,640 (1992) and 5,183,677 (1993), both to Lehtomaki et al describe a beta glucan enriched grain fiber, and a process for the preparation of a cellulose-containing, beta glucan enriched grain fiber. U.S. Pat. No. 5,512,287 to Wang et al. relates a method for extracting beta glucan from cereal grains, in which the beta glucan is precipitated and has a molecular weight in the range of 400,000-2,000,000 Daltons (“Da”).

WO 00/49052 (to Potter et al.) discusses an aqueous method for concentrating water soluble polysaccharides having molecular weights of at least about 50 kDa, including beta glucan having a molecular weight of greater than 2,000,000 Da. WO 98/13056 (to Morgan) relates a process for obtaining beta glucan that has an average molecular weight of 5,000 Da to 1,500,000 Da from cereal by extracting with water and without deactivation of enzymes associated with the cereal.

Also found in the prior art are non-cereal based beta glucan products, such as described in U.S. Pat. Nos. 6,020,324 and 6,143,731, both to Jamas et al., who relate the use of intact whole yeast beta glucan, i.e., 1→3, 1→6 beta glucan, in dietary supplements.

As to methodologies related to cholesterol reduction patents issued to Dressman et al., U.S. Pat. No. 5,576,306 and Gallaher et al., U.S. Pat. No. 5,585,366 are concerned with the use of water-soluble cellulose ethers for cholesterol reduction and focused solely on viscosity-related effects, and not on enhancement of bile acid binding.

Despite the above disclosures, there exists a continued need for improvements and advancements in this area.

### SUMMARY OF THE INVENTION

The present invention relates to an intermediate food product, such as dough, food additive, ingredient, seasoning or dietary supplement, finished food products (cereals, cereal bars, dairy products, bakery goods, prepared meals, dairy products such a yogurt and nutritional beverages, and the like) that have improved bile acid binding functionality which results in beneficial hypocholesterolemic effects. More specifically, the present invention pertains to the use of short chain beta glucans having a reduced number of starch and/or protein linkages in connection with the food product.

While a number of solutions have been suggested in the past that discuss the isolation of pure beta glucans of varying molecular weights and chain lengths, there still exists a need for a palatable food product which optimizes the use of dietary fiber. It has been surprisingly discovered that the beneficial effect of using beta glucans in food related products may actually be diminished where substantially all of the protein and/or starch is removed, as disclosed in the prior art, that is, attainment of pure beta glucans is the objective of the isolation suggested in the prior art solutions. Instead, it has been found that a particular molecular weight range of beta glucan, in the range of 500 to 2500 Da, more preferably 900-1800 Da, while retaining at lest 10% of the associated protein and starch may in fact maximize the effect of beta glucan in enhancing the binding capacity of bile acids and thus assist the consumer in lowering cholesterol levels.

It has been discovered that short chain beta-glucan can be added directly into a food product or food intermediate (dough) or as part of a food additive, seasoning or supplement which eliminates the need for costly and time intensive extraction procedures disclosed in the prior art, not isolating long chain, pure beta glucan. Thus the invention relates to improved methods and products produced thereby for the preparation of food intermediates, seasonings, additives, supplements and complete food products that have increased bile acid binding capacity resulting in improved hypocholesterolemic functionality.

In one preferred embodiment of the present invention, a method for improving the bile acid binding functionality of a food product or food product intermediate is provided and comprises the use of short chain beta-glucan which is obtained from a grain. Initially a food product or food product intermediate is provided to which is added at least one modifying agent to provide a food product or food product intermediate with improved bile acid binding functionality. The food product or food product intermediate is then prepared to produce a completed food product or food product intermediate which is ready for any further processing or consumption.

A still further embodiment of the present invention provide for a method for improving the bile acid binding functionality of a food product or food product intermediate having native beta glucan as a component and comprises first contacting the food product or food intermediate with at least one 1→4 beta glucanase; and then increasing the temperature of the food product or food intermediate to 110° C. for at least about 45 minutes to provide the food product or food intermediate comprising short chain beta glucan or modified short chain beta glucan.

A yet still further embodiment of the present invention relates to a novel food product or food product intermediate having improved bile acid binding capacity which comprises a grain selected from the group consisting of oat, barley, wheat or corn, a modifying agent; and a short chain or modified short chain beta glucan having a molecular weight in the range of about 500 to 2500 Da.

A still further embodiment of the present invention is directed to a novel cereal product having improved bile acid binding functionality, and comprises a short chain beta glucan or modified short chain beta glucan, in which the short chain beta glucan or modified short chain beta glucan resulted from an in situ modification of native beta glucan in the cereal.

A still further aspect of the present invention is to provide for the use of a short chain beta glucan having at least 10% of the protein and starch found in the grain.

These, as well as other objects and advantages of this invention, will be more completely understood and appreciated by referring to the following more detailed description of the presently preferred exemplary embodiments of the invention and the appended claims.

### BRIEF DESCRIPTION OF THE FIGURES

FIG. 1 shows molecular modeling depicting snapshot conformations of the 1→3-linkage beta glucan at 50 Pico-second intervals (a-d).

FIG. 2 shows molecular modeling depicting snapshot conformations of native oat beta glucan at 200 Pico-second intervals (a-d).

FIG. 3 shows molecular modeling depicting native oat beta glucan binding with taurocholate.

### DETAILED DESCRIPTION

Beta-D-glucan, or β (1→3, 1→4) glucosyl pyranose polymer, occurs in higher concentrations, generally around 3-8%, and principally in two common grain cereals, oats and barley, although other cereal grains such as wheat contain beta glucan. By way of comparison, cellulose is a straight chain of β (1→4) linked glucose molecules. Beta glucan has the same β (1→4) linkages as cellulose, but contains β (1→3) linkages after 3-4 β(1→4) linkages (Welch R. “Oats in human nutrition and health” in The Oat Crop. Chapman and Hall, London, p. 304, 1995). This general beta glucan structure will continue for 20,000 to 100,000 glucose units.

Beta glucan is a major polysaccharide of oat and barley, and is made of linear polymers composed of glucosyl residues linked via a mixture of β-(1→4) and β-(1→3) linkages in a ratio of about 2.3-3.0 to 1.0 (Izydorcyk et al., Journal of Cereal Science 27, pp. 321-325, 1998 and Welch Id.

Oat bran used in the present invention is produced by grinding clean oat groats or rolled oats and separating the resulting flour by suitable means, such as sieving, into fractions such that the oat bran fraction is not more then 50% of the original starting material. The separated fraction should have at least 5.5% of beta glucan (dry weight basis), and a total dietary fiber content of at least 16% (dry weight basis), so that at least one third of the total dietary fiber is soluble fiber.

Barley, as used in the present invention, is processed in a manner that resembles oats as set forth above, in that it consists of cleaning, hulling, sieving and then grinding. Waxy hulless barley has a higher dietary fiber content than most other sources of fiber and can range from 14 to 20% of the dry weight and have a beta glucan content of around 8 to 10%.

Beta glucan coexists in the cell with β-glucanases, which are enzymes that break up beta glucan. β-glucanases are released or activated as the grain is hydrated. Additionally, as the grains germinate, newly made β-glucanase is released from the scutellum and from the grain aleurone layer into the endosperm. Thus, as water is added to the grain, beta glucan is degraded and broken down into smaller units through the activity of β-glucanase. For example, extracted beta glucan can be treated with hydrolytic enzymes, such as laminarinase or β(1→3) glucanases, to reduce the degree of β(1→3) linkages of the extracted beta glucan, which results in a decrease in the viscosity profile.

Soluble fibers contained in or derived from natural sources such as cereal grains have been found to aid in the lowering of total and LDL cholesterol levels. Typically, the greatest amount of cholesterol reduction observed with soluble fibers is around 5-8%. Phytosterols have been observed to lower total cholesterol levels by as much as 8-12%, and pharmaceutical agents (HMG-CoA reductase inhibitors) are capable of lowering cholesterol levels by 20% or more. Formulating foods that are efficacious in lowering cholesterol by incorporating grain-based soluble fibers has been problematic. This is due to the relatively low proportion of soluble fibers in cereal grains, and variability in their efficacy, not to mention difficulties in creating palatable combinations that consumers are willing to ingest. In addition, certain side effects are attributable to food products and dietary supplements and additives that are high in fiber, can create undesirable gastrointestinal side effects such as flatulence, diarrhea, and abdominal cramps, making such products largely unacceptable, despite the perceived health benefit.

As used herein, “molecular weight” refers to the weight average molecular weight of a polysaccharide, e.g., beta glucan. The weight average molecular weight of beta glucan can be determined using size exclusion chromatography coupled with multi-angle light-scattering detector. As such, and for the purposes of illustrating the present invention a short chain beta glucan with a molecular weight range of 900 to 1,800 Da, for example, means that 60-80% of the beta glucan molecules have a molecular weight with a lower limit of around 900 Da and an upper limit of about 1800 Da, with virtually all having a molecular weight of less than 5,000 Da.

As used herein, “native beta glucan” describes beta glucan as found in nature from various grains, as well as specifically oat and/or barley beta glucan that has been treated with one or more amylases. Amylase is an enzyme that catalyzes the hydrolysis of α-1→4 glucosidic linkages of polysaccharides, such as beta glucan (The Merck Index, 15^{th} edition, 1997). Thus, native beta glucan is linked exclusively via a mixture of beta (1→3) and beta (1→4) linkages in a ratio of about 2.3-3.0 to 1.0 to about 2.6 to 1.0.

Native beta glucan is found primarily in the bran layer of the grain, i.e., the outer layer of the oat grain. Such native beta glucan is typically described in the literature as having an average molecular weight of about 1,200,000 Da. Treatment of native beta glucan with amylase reveals that the actual molecular weight of beta glucan is in the range of around 200,000 to 400,000 Da, probably closer to 200,000 to 300,000 Da.

As used herein, “short chain beta glucan” refers to native beta glucan that has been modified by an agent in such a manner as to render the average molecular weight of the beta glucan to be less than approximately 5,000 Da, and preferably in the range of 500 to 2,500 and more preferably about 900 to 1800 Da. As with native beta glucan, the short chain beta glucan of the invention is linked primarily via a mixture of beta (1→3) and beta (1→4) linkages (referred to as (1→3, 1→4)beta glucan). Contacting native beta glucan with an enzyme, such as a beta glucanase, can produce shorter chain (1→3, 1→4) beta glucan.

As used herein, “modifying agents” refer to any agent that is suitable for use in degrading native beta glucan to short chain beta glucan. For example, a modifying agent provided in an embodiment of the present invention includes an enzyme. Preferably, an enzyme such as a 1→4 beta glucanase, e.g., laminex BG (available from Genencor Corp. of Cambridge, Mass.) or multifect B (available from Genencor Corp. of Cambridge, Mass.) is used. In addition, modification may occur by chemical or physical modification by known techniques.

As used herein, “food product” or “food stuff” is defined for present purposes as a food material, dietary additive or supplement or food seasoning which is administered or delivered to or ingested or taken by an animal or human to induce a beneficial or desirable physical effect, i.e. nutrition.

A “cereal product” is a cereal-based food product and includes but is not limited to ready to eat cereals (“RTE”).

“Dough”, as used herein, refers to an intermediate food product that is made by combining water and cereal flour. In the creation of dough, a mixture of flour and water forms a continuous medium having an almost elastic property, into which other ingredients may be embedded. Dough is typically prepared by mixing, kneading and/or cooking flour with a limited amount of water, typically 30 to 45% of the total weight. It is often stiff enough to cut into various shapes or designs, or roll into desired patterns or other configurations. The dough is stable enough that such patterns or shapes can be frozen and will retain such shapes. Doughs are generally used to make low sugar-to-flour ratio products such as breads, quick breads, biscuits, scones, cereals, ready to eat cereals (RTE) and so on.

As used herein, “in situ modification” refers to the process by which a native beta glucan is modified to a short chain beta glucan in an intact dough mixture, i.e., the dough product is provided with short chain beta glucan via the modification of native beta glucan present within the dough product, as opposed to the introduction of short chain beta glucan to the dough product from an exogenous source. However, exogenous introduction, such as through the use of food seasonings, additives and supplements are within the scope of the present invention.

As used herein, “improved hypocholesterolemic functionality” refers to an increase in the lipid lowering and/or bile acid binding capacity of a composition comprising short chain beta glucan or modified short chain beta glucan as compared to native beta glucan. Short chain beta glucan can be manipulated in such a manner to improve its hypocholesterolemic activity. For example, short chain beta glucan can be subjected to cationic modification to improve bile acid binding capacity. In addition, short chain beta glucan can be hydrolyzed, e.g., by acid and/or enzymatic hydrolysis, or subjected to substitution with a hydrophobic group to increase bile acid binding capacity.

The ability of short chain beta glucans and modified short chain beta glucans to reduce total and LDL serum cholesterol levels can be determined using assays that are known in the art. In vivo and in vitro tests can be used to measure such increased capacity and are known to the art. For example, a bile acid binding assay or a [¹⁴C]-Taurocholate binding assay can be conducted to assess the cholesterol-lowering capacity of a short chain beta glucan or modified short chain beta glucan.

Preferably, a short chain beta glucan or modified short chain beta glucan of the invention has an ability to lower the levels of lipoproteins, that is increase by a factor of 2, more preferably by a factor of 5, and most preferably by a factor of 10, the increase of the binding capacity of bile acids when compared to native beta glucan.

Thus, it is believed that through the use of short chain beta glucans and modified short chain beta glucans of the present invention total and LDL serum cholesterol levels may be lowered.

Methods of the Invention to Modify Short Chain Beta Glucan

One of the current approaches of altering carbohydrate linkages or altering side chain functionality is through the addition of charged or hydrophobic groups to enhance bile acid binding capacity, and modification of degree of polymerization (reducing molecular weight and DP) have not been previously described as strategies for customizing polymers.

Methods to Increase the Bile Acid Binding Capacity of Short Chain Beta Glucan and Modified Short Chain Beta Glucan

Hydrolysis with either acid or enzyme will change molecular weight and affect bile acid binding capacity. Bile acids are negatively charged at neutral pH and as such, by adding a cationic group to a fiber, bile acid binding capacity will increase. The following are methods to provide short chain beta glucan or modified short chain beta glucan with an increased bile acid binding capacity.

Cationic modification of biopolymers increases the capacity of the material to bind bile acid anions (Lee et al., Biosci. Biotech. & Biochem., 63, 833 (1999)). The chemical modification of short chain beta glucan to incorporate cations into the carbohydrate polymer will result in increased bile acid binding capacity and therefore greater efficacy in cholesterol reduction.

For example, two modifying molecules that can be reacted with short chain beta glucan are lysine, a basic amino acid comprised of two cationic amine groups and one anionic carboxylic acid group, and glucosamine, a basic carbohydrate comprised of one cationic amine group.

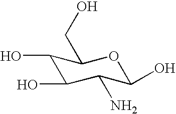

In the case of lysine, chemical modification of beta glucan can be carried out by converting lysine to the glycosamino acid following conventional peptide synthesis coupling techniques for ligation (McDevitt and Lansbury, J. Am. Chem. Soc., 118 3818-3828 (1996)).

In the case of glucosamine, chemical modification of beta glucan would be carried out by using a high-yielding, three-step procedure to convert unprotected carbohydrates into N-allylglycosides prior to polymerization with glucosamine (Spevak et al., J. Org. Chem., 61, 3417-3422 (1996)).

Methods to Measure Improved Hypocholesterolemic Functionality of Short Chain Beta Glucan and Modified Short Chain Beta Glucan

Numerous researchers have established a relationship between bile acid binding capacity by ingested material and concomitant reduction in serum cholesterol. This assay is designed to assess a food product's cholesterol-lowering capacity by measuring its capacity to bind bile acids. The following are methods by which an improved bile acid binding capacity is obtained resulting in beneficial hypocholesterolemic activity from the use of short chain beta glucan and modified short chain beta glucan and ways this may be measured.

1. [¹⁴C]-Taurocholate NEC665, Available from Perkin Elmer Life Sicence Binding Assay—Radioactive Assay.

Test samples are weighed out in triplicate (15 mg/reaction) and placed in capped 14 ml polypropylene test tubes. 2 mls of Binding Buffer A (0.1 M KH₂PO₄, pH 6.9; 10 ml sodium taurocholate; and 0.01 mCi [¹⁴C]-taurocholate in a final volume of 100 ml) is added to each sample tube, vortexed and allowed to incubate with constant shaking at 37° C. for 2 hours.

At the end of the reaction, the samples are removed to room temperature, vortexed and replicate 800 μl aliquots are pipetted into the inserts of 0.45 um nylon-66 spin filters. The spin filters are centrifuged at 5,000×g for 30 minutes. The insert is transferred to a fresh receiver and centrifuged again at 5,000×g for 10 minutes to remove any additional buffer. The filtrate is retained from both receivers.

The spin filter inserts are then modified to fit into 20 ml borosilicate glass scintillation vials, 15 ml of scintillation fluid is added and each sample is counted for ¹⁴C-dpm. The filtrates of each sample (10 μl; 2 replicates) are pipetted into 20 ml borosilicate glass scintillation vials, 15 ml of scintillation fluid is added and each sample is counted for ¹⁴C-dpm. As a control, Binding Buffer A (10 μl; 6 replicates) is pipetted into 20 ml borosilicate glass scintillation vials, 15 ml of scintillation fluid is added and each sample is counted for ¹⁴C-dpm. This yields the specific activity of the buffer and the control value for determining the percent bile acid bound by the filtrate measurement.

2. Bile Acid Binding Test—Non-Radioactive Assay.

To measure bile acid binding capacity, the Sigma Bile Acid Assay (Sigma #450-A, Bile Acids kit) is conducted in accordance with the manufacturer's instructions.

First, the interfering antioxidants are removed from the samples. 2×10 mg portions of ground sample (through 1 mm screen) in 2 separate disposable test tubes (13×100 mm) are weighed. One portion is sample blank and the other is test. 2 mls of 50% MeOH is added, and is stirred at 400 rpm for 1 hour at room temperature. Then, the sample is centrifuged at 2,000 rpm for 10 minutes at 25° C. The supernatant is decanted. This MeOH wash is repeated twice more. The sample is dried overnight at room temperature, or, in the alternative, is dried using a SpeedVac.

To determine bile acid binding, 2 ml of 10 ml bile acid solution are added to the test sample. 2 mls of 0.1 M phosphate buffer is added to the sample blank. The sample and blank are stirred at 400 rpm for 2 hours at 37/C. Each is then centrifuged at 2,000 rpm for 10 minutes at 25/C. The resulting supernatants are assayed for unbound bile acid.

As a standard control, 2 ml of 10 ml bile acid solution is added to an empty tube. This is stirred at 400 rpm for 2 hours at room temperature. The solution is assayed for bile acid at three different concentrations (2.5, 5.0, and 10.0 ml).

For the assay, bile acid reagents A and B of the Sigma Bile Acid Binding Assay kit are prepared following Sigma Procedure #450. Just prior to the assay, one part of Reagent A is mixed with one part of Reagent B, to produce Reagent AB. 100 μl of the sample blank supernatant is pipetted into a disposable cuvette. 100 μl of 10 ml bile acid solution is added to the cuvette. In another cuvette, 100 μl of the test supernatant is pipetted, to which 100 μl of phosphate buffer (0.1M phosphate buffer, pH 7). 0.5 ml of reagent AB is then added to each cuvette at 30-45 second interval. This is incubated 5 min at 37° C. Then, 1 ml of distilled water is added and mixed, and the absorbance at 530 nm is read. The concentration of bile acid in solution may then be calculated by digesting dough with amylases to remove starch, lipases used to remove fat and proteases are then used to remove protein.

Molecular Weight Determination of Short Chain Beta Glucan or Modified Short Chain Beta Glucan

To determine the molecular weight of short chain beta glucan or modified short chain beta glucan, each precipitated by the addition of 4 parts 95% ethanol to 1 part of the beta glucan solution. The mixture is kept at 10° C. overnight before centrifuging at 5,000 rpm for 30 minutes. The supernatant is discarded and the precipitate is dried at room temperature.

The dried beta glucan is then dispersed by stirring in 50 mM NaOH at 45-50° C. The solution is then filtered through 0.45 mm filter.

The molecular weight of beta glucan is determined using size exclusion chromatography coupled with multi-angle, light-scattering detector. HPLC is then conducted using a Waters UltraHydrogel 2000 (7.8×300 mm) column at 25° C., with 50 ml NaOH as the solution buffer at a flow rate of 0.65 ml/minute. Detection is accomplished utilizing a Waters R410 Differential Refractometer and a Wyatt DAWN-DSP Laser Photometer.

The present invention is now illustrated in greater detail by way of the following examples, which incorporate the foregoing methodologies. It should be understood that the present invention is not to be construed as being limited thereto and may encompass other methods or procedures.

### EXAMPLE 1

### An “In-Process” Enzymatic Modification of Soluble Fiber Controlled Hydrolysis of Beta Glucan During RTE Cereal or Dough Processing

Dry ingredients, oat or barley flour were mixed and poured into a brabender Plasti-Corder Type Epl-V7752 mixing bowl. Water or enzyme solution was then added to the bowl.

The dough was cooked at 110° C. for 45 minutes. Torque was recorded during cooking. After cooking, the dough was extruded in a macaroni press having a die with holes approximately 5/16″. The pellets were dried to approximately 9 to 11% moisture content in a Blue-M oven, available from Stabil-Therm set at 212° F. for 60 minutes. The dried pellets were screened through screen sieves. The pellets were then puffed using a hot air popcorn popper that was heated to 420° F.

### EXAMPLE II

### Molecular Modeling of Beta Glucan, Short Chain Betaglucan, and Modified Short Chain Beta Glucan Materials and Methods

Molecular models were constructed for different types of polysaccharide chains. Various chain lengths of 100, 50, 25, 10, and 5 repeating glucose units were studied. Molecular dynamics simulations were carried out on these mainly extended models to search for stable conformations of polysaccharide chains. These simulations were first carried out for the 100 unit beta glucan chains, including the 1,3 linkage beta glucan and the natural oat and barley beta glucan (1,3 to 1,4 linkage ratio 1:2.6), without ligands (bile acid molecule). After the stable conformations were obtained, the taurocholate molecule was placed randomly near the stable beta glucan structure for the binding study. For each type of beta glucan, four conformations were used. The taurocholate molecule was placed in five different positions near each beta glucan conformation. Altogether, 20 simulations were performed for binding of each type of beta glucan. Each simulation lasted for 200 Pico-seconds and structures were recorded every Pico-second. The binding energy was calculated by averaging over all the conformations (20×200). For shorter chains, similar procedures were applied.

All the molecular dynamics simulations were carried out at room temperature (298K) with the MSI (Molecular Simulations Inc.) software and the Compass force field.

Results

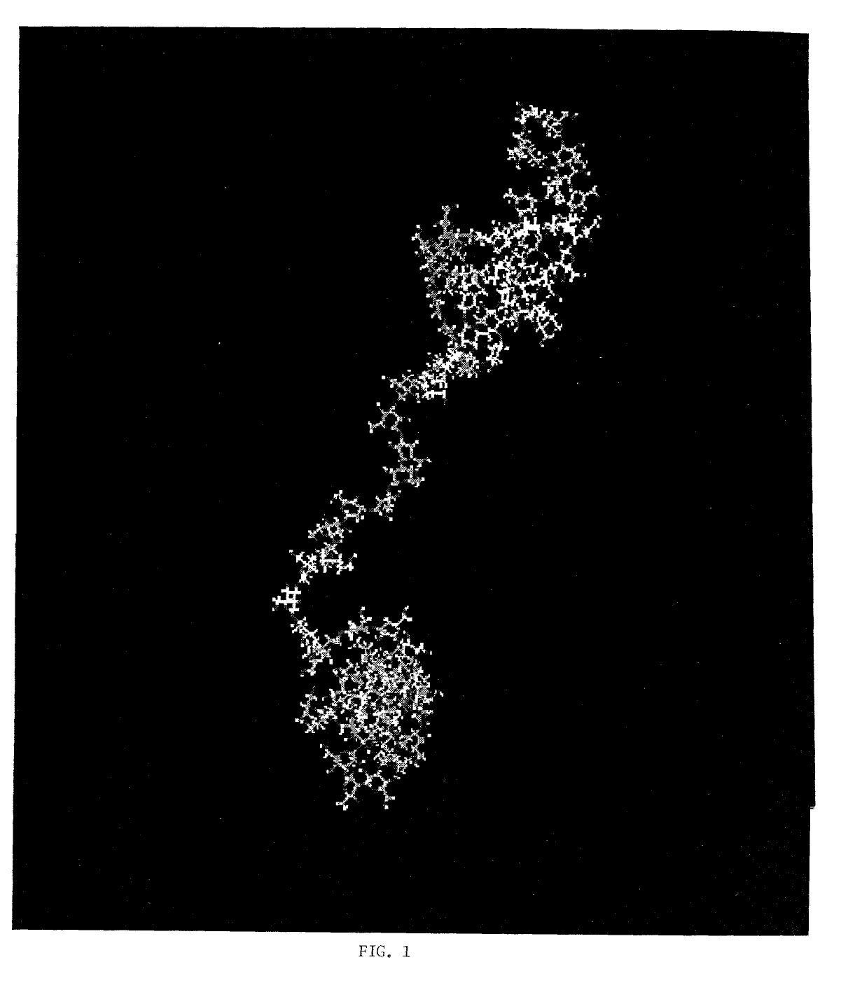

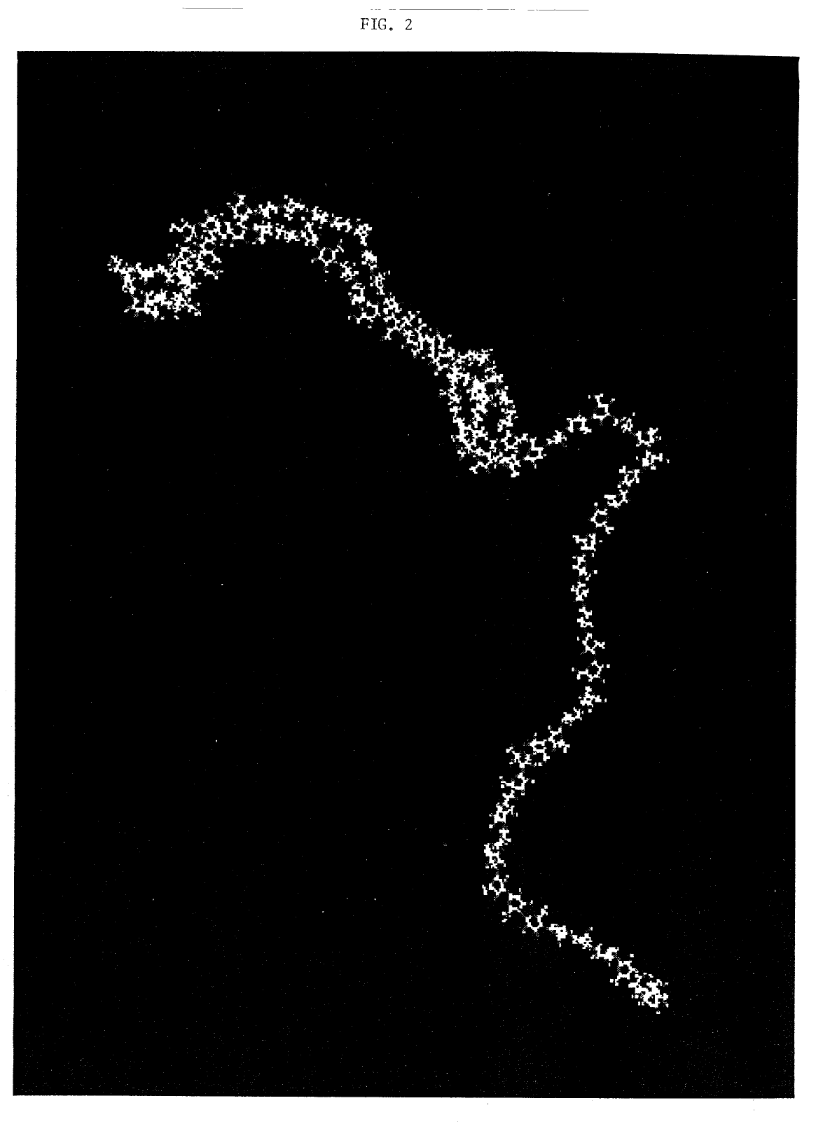

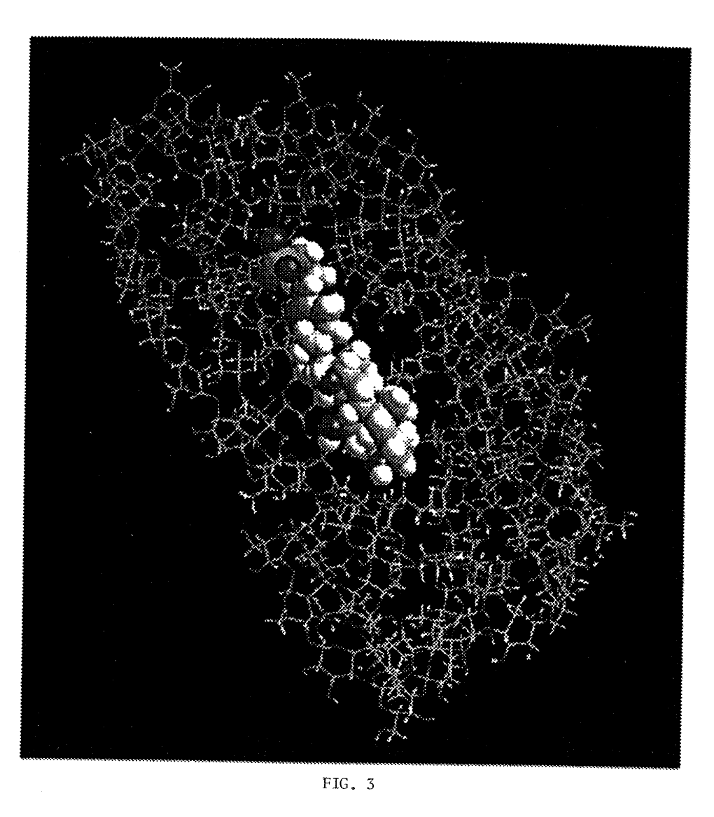

During these simulations, the extended conformations of both types of beta glucans were not stable, but the folding of the two types of chains was qualitatively different. The 1,3 linkage beta glucan formed a coil-like stable structure quickly (FIG. 1), whereas natural oat beta glucan took a much longer time to fold, and its stable structure consisted of strands (FIG. 2). The 1,3 linkage beta glucan had stronger self-interaction among its segments and preferred aggregation, which is consistent with its very low solubility observed experimentally. In the simulations, the 1,3 linkage beta glucan did not bind well to taurocholate. In contrast, the natural oat beta glucan bound better to taurocholate. FIG. 3 shows a structure of a binding complex of natural oat beta glucan and taurocholate. The calculated binding energies are in correct rank order. Without considering the self-interaction, an extended model gives stronger binding for 1,3 linkage beta glucan, which is incorrect when compared with experimental observations. Therefore, the self-interaction among the chain segments, including aggregation, is a major competing factor for determining bile acid binding capacity, and a rational approach to improve bile acid binding capacity is to reduce this interaction. Cutting a long chain into short segments by breaking the covalent bond linkage is one way to reduce the self-interaction (and aggregation). Further modeling on short chains supported this idea.

In general, it is believed that longer chains provide more possible binding sites for a single ligand and, consequently, stronger binding may typically be expected. However, when aggregation becomes a competing factor, short chain can better adjust its conformation to achieve optimal binding. Modeling of 1,3 beta glucan showed that a 10-unit chain can bind to a taurocholate molecule as strong as a 100-unit chain. Corresponding to a constant molecular ratio of binding, comparison could be made between a long chain binding with more ligands and a short chain binding with fewer ligands. Without aggregation, short chains have larger average exposed area per monomer unit for interactions with ligands than long chains. Modeling of natural oat beta glucan showed that binding of a 25-unit chain with 2 taurocholate molecules (corresponding to a realistic binding ratio) has about the same strength for each taurocholate molecule as that of a 100-unit chain with 8 taurocholate molecules.

These modeling studies showed that a beta glucan segment containing 10 to 100 glucose units can bind well with taurocholate, whereas a segment with 5 glucose units cannot. Experimentally, how to cut beta glucan to such short segments and present them from aggregation is an important issue for successful binding studies.

Modeling suggests that the conformation of low molecular weight beta glucan fractions will interact with bile acids at least as strongly as and possibly more strongly than large beta glucan molecules. A larger number of small molecules may be significantly more efficacious than fewer large molecules.

All publications, patents and patent applications are incorporated herein by reference.

It will thus be seen according to the present invention a highly advantageous and beneficial food product or food intermediate which incorporates short chain beta glucan and modified short chain beta glucan has been provided. While the invention has been described in connection with what is presently considered to be the most practical and preferred embodiment, it will be apparent to those of ordinary skill in the art that the invention is not to be limited to the disclosed embodiment, that many modifications and equivalent arrangements may be made thereof within the scope of the invention, which scope is to be accorded the broadest interpretation of the appended claims so as to encompass all equivalent structures and products.

What is claimed is:

1. A method for improving bile acid binding functionality of a food product or food product intermediate comprising short chain beta-glucan, comprising:
obtaining a short chain beta glucan from a grain;
providing a food product or food product intermediate;
adding to the food product or food product intermediate at least one modifying agent to provide a food product or food product intermediate with improved bile acid binding functionality; and
preparing the food product or food intermediate.

2. The method of claim 1 wherein the modifying agent is an enzyme.

3. The method of claim 2 wherein the enzyme is a 1→4 beta glucanase.

4. The method of claim 3 wherein the 1→4 beta glucanase comprises laminex BG.

5. The method of claim 3 wherein the 1→4 β-glucanase comprises multifect B.

6. The method of claim 1, wherein the short chain beta glucan has a molecular weight which is less than about 5,000 Da.

7. The method of claim 6, wherein the short chain beta glucan has a molecular weight which is in the range of about 500-2500 Da.

8. The method of claim 6, wherein the short chain beta glucan has a molecular weight which is in the range of about 900-1800 Da.

9. The method of claim 1, further comprising contacting the food product or food product intermediate with an additional modifying agent so as to provide modified short chain beta-glucan.

10. A food product or food product intermediate having improved bile acid binding capacity comprising;
a grain selected from the group consisting of oat, barley, wheat or corn;
a modifying agent; and
a short chain or modified short chain beta glucan having an average molecular weight of less than 5,000 Da.

11. A cereal product with improved bile acid binding functionality, comprising;
short chain beta glucan or modified short chain beta glucan; and
wherein the short chain beta glucan or modified short chain beta glucan resulted from in situ modification of native beta glucan in the cereal.

12. The cereal product of claim 11, wherein the short chain beta glucan is less than about 5,000 Da.

13. The cereal product of claim 11, wherein the short chain beta glucan is in the range of about 900-1800 Da.

14. The cereal product of claim 11, wherein the in situ modification comprises enzymatic treatment.

15. The cereal product of claim 11, wherein the enzymatic treatment comprises treatment with a 1→4 beta glucanase.

16. The cereal product as recited in claim 11 wherein the cereal product is selected from the group consisting of ready-to-eat cereals, cereal bars, cookies, granola bars, snack bars, chews, breads, ready to eat meals and muffins.

17. A food product or food intermediate as recited in claim 10, wherein the food product is selected from the group consisting of ready-to-eat cereals, cereal bars, cookies, granola bars, snack bars, chews, breads, ready to eat meals and muffins and dairy products.

18. A method for improving the bile acid binding functionality of a food product or food product intermediate having native beta glucan as a component, comprising:
contacting the food product or food intermediate with at least one 1→4 beta glucanase; and
increasing the temperature of the food product or food intermediate to 110° C. for at least about 45 minutes to provide the food product or food intermediate comprising short chain beta glucan or modified short chain beta glucan.

19. A method for improving bile acid binding functionality of a food product or food product intermediate as recited in claim 1, wherein the short chain beta glucan retains at least 10% of starch and protein associated with such grain.

20. A food product or food product intermediate as recited in claim 10, wherein the short chain beta glucan retains at least 10% of starch and protein associated with such grain.
